(19) United States
(12) Patent Application Publication
(10) Pub. No.: US 2022/0347702 A1
(43) Pub. Date: Nov. 3, 2022

(54) Cold Gas Spraying System Having an Adjustable Particle Jet

(71) Applicant: Siemens Aktiengesellschaft, München (DE)

(72) Inventors: Axel Arndt, Berlin (DE); Jens Dahl Jensen, Berlin (DE); Aline Creuz, Berlin (DE); Ursus Krüger, Berlin (DE); Uwe Pyritz, Berlin (DE); Oliver Stier, Berlin (DE)

(73) Assignee: Siemens Aktiengesellschaft, München (DE)

(21) Appl. No.: 17/641,623

(22) PCT Filed: Aug. 13, 2020
(86) PCT No.: PCT/EP2020/072771

§ 371 Date: Mar. 9, 2022

(30) Foreign Application Priority Data
Sep. 9, 2019 (EP) 19196216.6

(51) Int. Cl. B05B 7/14; C23C 24/04; B05B 12/14

(52) U.S. Cl. CPC B05B 7/1404; C23C 24/04; B05B 12/14

(57) ABSTRACT

Various embodiments include a cold gas spraying system for generating an adjustable particle jet. The system may include: a nozzle from which the particle jet emerges; a supply device for supplying a particle stream to the nozzle; and one or more actuators operable to reduce the particle stream and/or the particle jet during operation. At least one of the actuators comprises a valve arranged between the supply device and the nozzle.

### CROSS-REFERENCE TO RELATED APPLICATIONS

This application is a U.S. National Stage Application of International Application No. PCT/EP2020/072772 filed Aug. 13, 2020, which designates the United States of America, and claims priority to EP Application No. 19196216.6 filed Sep. 9, 2019, the contents of which are hereby incorporated by reference in their entirety.

### TECHNICAL FIELD

The present disclosure relates to cold gas spraying systems. Various embodiments of the teachings herein may include systems for generating an adjustable particle jet and/or methods for controlling such a cold gas spraying system.

### BACKGROUND

Cold gas spraying (cold spraying) is a method in which a material in powder form is applied at very high speed to a carrier material (substrate). For this purpose, a process gas (for example nitrogen) heated to several hundred degrees is accelerated to a very high speed, for example supersonic speed, by expansion in a De Laval nozzle and subsequently the powder particles are injected into the gas jet. The injected powder particles are in this case accelerated to such a high speed that, by contrast with other thermal spraying methods, they form a dense and firmly adhering layer when they collide with the substrate, even without preceding melting or incipient melting.

On account of the thermal inertia of cold spraying systems, the flow parameters of the gas jet that accelerates the particles cannot be changed abruptly. Furthermore, it is unsuitable to switch the powder conveyor or conveyors off and on again abruptly because, owing to the length of the lines, they need a while until uniform conveyance is resumed again after that. Powder conveyors are also referred to hereinafter as the supply device and serve for supplying a particle stream (powder stream). The quality of the material that is built up however depends decisively on uniform conveyance. In other words, the system should as far as possible generate (spray) a particle jet that is as uniform as possible.

When coating components or performing additive manufacturing on components by cold gas spraying, the inadequate controllability of the particle jet or inadequate dynamics of the parameters of the particle jet leads to problems, for example too much material is deposited at some locations, including where, because of kinematic limitations, the spray nozzle has to be moved more slowly than would be appropriate for the powder conveying rate at the time.

### SUMMARY

The teachings of the present disclosure may be used to selectively control the particle jet of a cold gas spraying system during operation, in particular to deactivate it for a short period of time. For example, some embodiments include a cold gas spraying system (100) for generating an adjustable particle jet (50), having a nozzle (110), from which the particle jet (50) emerges, a supply device (130), for supplying a particle stream (40) to the nozzle (110), and one or more actuators (21, 22, 23), which are formed such that the particle stream (40) and/or the particle jet (50) can be temporarily reduced, in particular temporarily interrupted, during operation, at least one of the actuators (21, 22, 23) being formed as a valve which is arranged between the supply device (130) and the nozzle (110).

In some embodiments, at least one of the actuators (21, 22, 23) is arranged downstream of the supply device (130).

In some embodiments, at least one of the actuators (21, 22, 23) is formed as a valve which is arranged such that the particle stream (40) is directed back into the supply device (130).

In some embodiments, there's at least one buffer (180) which is formed at least for temporarily buffering the particle stream (40).

In some embodiments, at least one of the actuators (21, 22, 23) is formed so as, in a first position (A), to supply the particle stream (40) to the nozzle (110) and, in a second position (B), to direct the particle stream into a buffer (180).

In some embodiments, there is a control device (CTRL) which is formed for adjusting a conveying rate of the supply device (130) in a dependence on at least a state of one of the actuators (21, 22, 23).

In some embodiments, there is a control device (CTRL) formed for adjusting a conveying rate of the supply device (130) in dependence on at least a traveling speed of the nozzle (110).

In some embodiments, there are particle lines (13, 13A, 13B) being formed as buffers (180).

In some embodiments, at least one of the actuators (21, 22, 23) is designed in such a way that a traveling speed of the nozzle (110) is adjustable dependently on the temporary reduction, in particular interruption, of the particle jet (50) and/or the particle stream (40).

In some embodiments, at least one of the actuators (21, 22, 23) is designed as a mechanical element (23, 24) which blocks and/or deflects the particle jet (50) after it emerges from the nozzle (110).

As another example, some embodiments include a method for controlling a cold gas spraying system (100) as described herein, a particle stream (40) being provided by a supply device (130), at least one actuator (21, 22, 23) being activated during operation for at least temporarily reducing, in particular temporarily interrupting, the particle stream (40) and/or the particle jet (50).

In some embodiments, at least one of the actuators (21, 22, 23) is activated dependently on a traveling speed of the nozzle (110).

In some embodiments, at least one actuator (21, 22, 23) is activated dependently on a conveying rate of the supply device (130).

In some embodiments, a conveying rate of the supply device (130) is controlled dependently on a state of at least one actuator (21, 22, 23).

### BRIEF DESCRIPTION OF THE DRAWINGS

The teachings herein are described and explained in more detail below on the basis of the exemplary embodiments that are represented in the figures, in which:

FIG. 1 shows a cold gas spraying system incorporating teachings of the present disclosure;

FIG. 2 shows a further cold gas spraying system incorporating teachings of the present disclosure;

FIG. 3 shows an actuator incorporating teachings of the present disclosure; and

FIG. 4 shows a further actuator incorporating teachings of the present disclosure.

### DETAILED DESCRIPTION

The present disclosure describes cold gas spraying systems and/or methods for generating an adjustable particle jet. For example, some embodiments include a system with a nozzle, the particle jet emerging from the nozzle during the operation of the cold gas spraying system. The particle jet comprises particles that are to be deposited on the substrate to be coated and a propellant gas. The cold gas spraying system also has a supply device for supplying a particle stream to the nozzle. The particle stream is a stream of powder particles which is made available to the nozzle and is accelerated in the nozzle to supersonic speed. The particle stream accordingly has a speed that is well below the speed of sound. The particle stream is formed as a particle-gas mixture and is in this case a two-phase flow of conveying gas with solid particles therein.

The cold gas spraying system also has one or more actuators, the actuators being formed such that the particle stream and/or the particle jet can be temporarily reduced during operation. In particular, the particle stream and/or the jet may also be interrupted for a short period of time. In other words, the actuators can be activated in such a way that temporarily no particles or at least only a few particles emerge from the nozzle. This can be used to create complex structures by means of the cold gas spraying method. Furthermore, this has the great advantage that powder that is not used for building up a structure is not used up in the non-active state, but instead the particle stream is only interrupted, and consequently powder can be saved. The temporary interruption or reduction has in this case a maximum duration of a few seconds, for example until a void in a three-dimensional structure has been passed by the nozzle. In some embodiments, the interruption is at most 1 second, in particular at most 0.5 of a second.

In some embodiments, at least one of the actuators is formed as a valve. The valve is in this case arranged between the supply device and the nozzle. With the valve, the particle stream from the supply device to the nozzle can be interrupted or reduced for a short period of time. The valve may in this case be formed such that a conveying gas stream, that is to say the particle stream with its conveying gas, is directed back into the supply device.

In some embodiments, the cold gas spraying system has a system in which the supply device with a conveying gas stream is under the same pressure. A control device which controls the conveying gas stream can in this way be retained, since, because of the same counter pressure, it only finds out at a later time that the valve is closed, and consequently only provides counteracting closed-loop or open-loop control later. In this case, the valve should be regularly opened, in order that the pressure in the supply device, for example the powder conveyor, does not become too great.

In some embodiments, at least one of the actuators of the supply device is arranged downstream. This may be achieved by the actuator being arranged such that the nozzle can no longer be supplied with a particle stream by the supply device. In some embodiments, the actuator has much higher dynamics than the supply device, the main task of which is to provide a particle stream that is as constant as possible. Utilizing the higher dynamics of the actuator, the particle stream can be adjusted to be more finely grained.

In some embodiments, at least one of the actuators is formed as a valve which is arranged such that the particle stream is directed back into the supply device. In particular, the particle stream with its conveying gas is directed back into the supply device. In some embodiments, the particle stream is sent into a pressurized powder container. The valve may be provided in the form of a ball valve. In some embodiments, in this way existing systems can be expanded.

In some embodiments, the cold gas spraying system has at least one buffer for temporarily buffering the particle stream. The buffer may in this case be designed such that a particle stream or the conveying gas stream with the particles is buffered, if possible while maintaining the same pressure level. Expansion vessels or surge tanks can be used here for example.

In some embodiments, at least one of the actuators is formed so as, in a first position, to supply the particle stream to the nozzle and, in a second position, to direct the particle stream into a buffer. It is possible that there are not just two discrete positions, but also intermediate positions, in which at least parts of the particle stream are directed into the buffer. For this purpose, corresponding valves could be provided. The advantage of a solution with a corresponding actuator and a buffer is that in this way existing systems can be retrofitted, since sudden changes in pressure can be avoided by the buffer.

In some embodiments, the cold gas spraying system has a control device which is formed for adjusting a conveying rate of the supply device in dependence on at least a state of one of the actuators. This has the great advantage that the actuator does not have to handle the entire particle stream, but at least a reduction of the particle stream can be provided. If the supply device is then adjusted such that the adjusting operations are sufficiently dynamic to ensure a particle jet that is as continuous as possible, very high dynamics of the amount of particles of the particle jet can be achieved in combination with the actuators.

In some embodiments, the cold gas spraying system has at least one control device which is formed for adjusting a conveying rate of the supply device in dependence on at least a traveling speed of the nozzle. The conveying speed of the supply device is in this case a measure of the number of particles that the conveying device conveys per unit of time. This allows the particle stream to be influenced directly. Since, however, this generally cannot happen dynamically enough to achieve reductions or interruptions of the particle jet for a short period of time, the traveling speed of the nozzle may be additionally influenced. With the particle stream remaining the same and the traveling speed increasing, the number of particles that are deposited at one location on the substrate falls. If the traveling speed is then increased and the conveying rate is at the same time lowered, an effect similar to reducing or interrupting the particle stream or the particle jet for a short period of time can be achieved. In some embodiments, the control device may be formed both the conveying rate in dependence on a state of an actuator and the traveling speed of the nozzle.

In some embodiments, the cold gas spraying system has particle lines which are formed as buffers. If only interruptions of the particle stream for a short period of time are intended, particle lines can be used unchanged. If interruptions for a longer period of time, and accompanying buffering of higher pressures, are intended, rather sturdier particle lines may be used. Existing systems can in this way be easily and advantageously expanded.

In some embodiments, at least one of the actuators is designed such that a traveling speed of the nozzle is adjustable dependently on the temporary reduction, in particular interruption, of the particle jet and/or the particle stream. Thus, for example, a robot arm that correspondingly adjusts the traveling speed of the nozzle may be provided. In particular in combination with further actuators, this is of great advantage.

In some embodiments, at least one of the actuators is formed as a mechanical element which blocks and/or deflects the particle jet after it emerges from the nozzle. Such mechanical elements may be formed for example as a kind of orifice plate that can be opened and closed. In addition and/or as an alternative, the mechanical element may be formed as a drum-shaped or cylindrical element which has channels that allow the jet to pass through and has channels that direct the jet away, for example to the side. This has the advantage that very high dynamics can be achieved and it can be ensured that no particles hit the substrate to be coated. This may be of advantage in particular in the case of particularly sensitive parts of the substrate that absolutely must not be hit by the particle jet.

In some embodiments, methods for controlling a cold gas spraying system that is formed as above, as provided by a system as described above. For operating the cold gas spraying system, at least one actuator is activated during operation for at least temporarily reducing, in particular for at least temporarily interrupting, the particle stream and/or the particle jet.

In some embodiments, at least one of the actuators is activated dependently on a traveling speed of the nozzle. This allows an exact adaptation of the particle jet or the amount of particles arriving on the substrate by adaptation of the traveling speed.

In some embodiments, at least one actuator is activated dependently on a conveying rate of the supply device. This has the great advantage that, by means of the conveying rate, at the same time the actuator can also be activated, and consequently the conveying rate controller can be used for activating an actuator.

In some embodiments, the conveying rate of the supply device is activated dependently on a state of at least one actuator. It is thus conceivable for example that, when an actuator is used for blocking or restricting the path of the particle stream, in parallel the feed rate of the supply device is restricted, and this is correspondingly increased again before the actuator opens again, so that sudden changes in pressure in the system can be avoided and particle conveyance that is as uniform as possible can be provided for a particle jet that is as uniform as possible.

In some embodiments, the various methods can be combined with one another and supplement one another. The various actuators mentioned can also be combined with one another in order in this way to obtain a system that is particularly dynamic and can be controlled particularly well, in order to obtain alternatives for the activation and/or allow reserves in the activation of the cold gas spraying system.

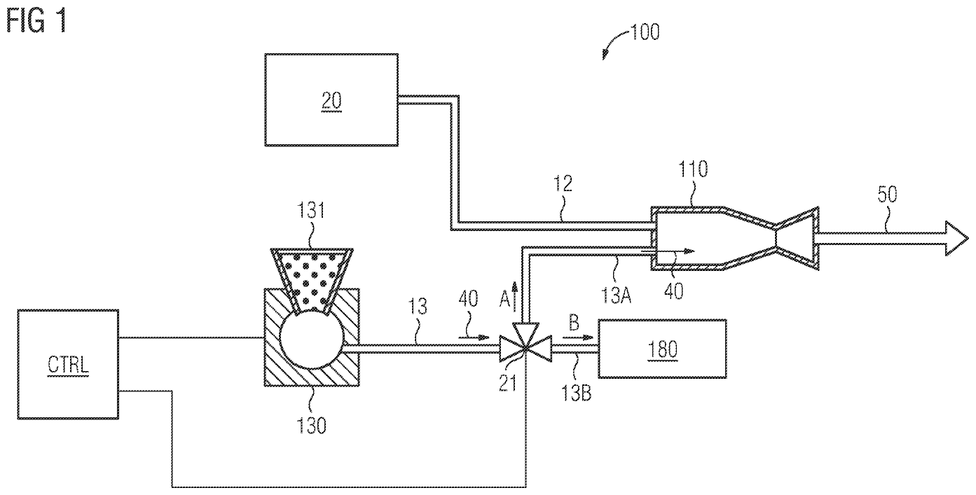

FIG. 1 shows a cold gas spraying system 100 having a nozzle 110, from which a particle jet 50 emerges. The nozzle 110 is supplied with a propellant gas under pressure from a gas source 20 by way of a gas line 12. Furthermore, the nozzle 110 is supplied with a particle stream 40 by way of a particle line 13A. A supply device 130 has a particle store 131 and is connected to an actuator 21 by way of a particle line 13. The actuator 21 has two positions A and B. The actuator 21 may in this case be formed for example as a valve. In position A, the particle stream 40 is sent unchanged to the nozzle 110 by way of the particle lines 13A. In position B, the particle stream 40 is directed into a buffer 180 by way of a particle line 13B. In position B, the particle stream 40 is therefore reduced or blocked in the direction of the nozzle 110 such that the particle jet 50 has a smaller number of particles or no longer has any particles.

By way of example, the cold gas spraying system 100 has a control device CTRL. The control device CTRL is in this case formed and incorporated in the system such that it can adjust a conveying rate of the supply device 130. This may take place for example by way of a rotational speed of a drum conveyor. Furthermore, the control device CTRL is connected to the actuator 21 and can activate the actuator 21. It is consequently conceivable that the control device CTRL activates the actuator 21 or the supply device 130 separately from one another. This may be advantageous in cases in which only a slight adaptation of the particle jet 50 is necessary. Furthermore, it is conceivable that the control device CTRL activates the actuator 21 and the supply device 130 together and in coordination with one another.

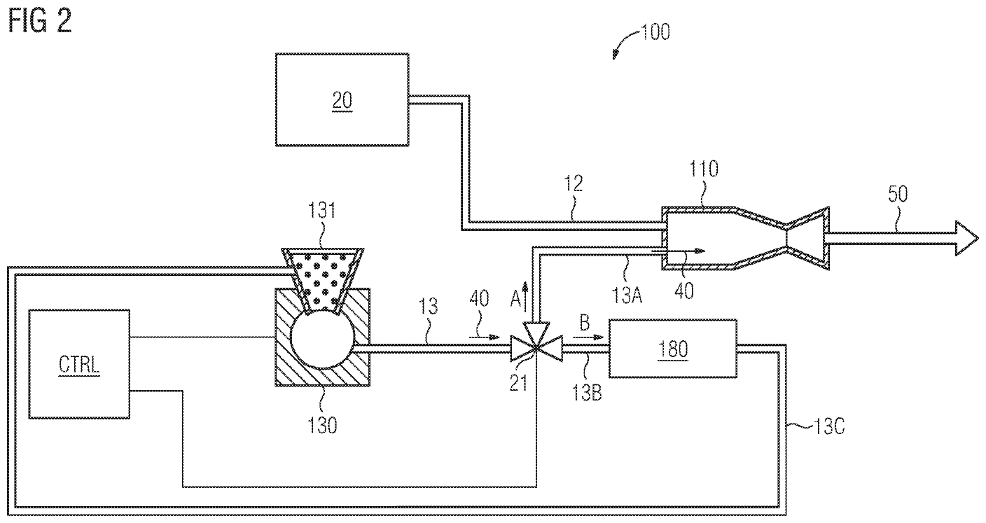

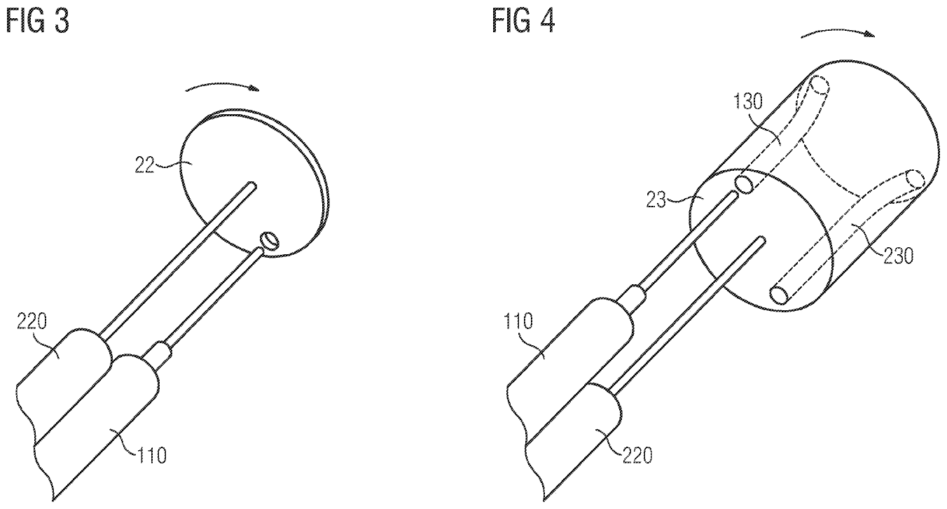

In some embodiments, further actuators 22 and 23 may also be provided, as they are shown in FIGS. 2 and 3; these may similarly be activated by the control device CTRL.

FIG. 2 shows a cold gas spraying system 100 on the basis of the embodiment from FIG. 1. In this case, a further particle line 13C, which is connected to the particle store 131, and consequently returns the accumulated gas with the unused particles, has been provided downstream of the buffer 180. Since the particle store 131 may also be under pressure, the conveying gas, which is then under almost the same pressure, can then be returned with the particles into the particle store 131 by way of the particle line 13C. The buffer 180 may also be omitted and the particle line 13B and particle line 13C connected directly to one another. This is the case for example when there are sufficient line lengths of the lines 13B and 13C and/or required short interruption times. The line length, possibly together with the additional buffer 180, advantageously has the effect that, with sufficiently short interruption times, no disturbing pressure control fluctuations are encountered in the powder conveying circuit, and therefore the suppression of the particle injection into the nozzle takes place unnoticed by the powder conveying system or its controller.

FIG. 3 shows an actuator 22, which in this case is designed as a kind of orifice plate, for example as a round orifice plate with one or more clearances. By rotation by means of a rotary drive 220, the actuator 22 can be adjusted such that a particle jet that emerges from the nozzle 110 does not hit the substrate. It should be mentioned here that the drawing is only schematic and the actuators 22 formed as mechanical elements can also be made much more compact.

In FIG. 4 there can be seen a similar concept of an actuator 23, which is formed here as a drum and has deflecting channels 230. The deflecting channels deflect the particle jet from the nozzle 110 out of the focus area, and consequently likewise have the effect that the particle jet can be interrupted for a short time. As an alternative or in addition to the deflecting channels 230, blind holes, which are formed for receiving the particle jet and its particles for a short period of time, may also be provided in the drum or in the cylindrical actuator 23.

In some embodiments, there is a cold gas spraying system (100) for generating an adjustable particle jet (50) and/or a method for controlling such a cold gas spraying system (100). In order to specifically control the particle jet (50) of the cold gas spraying system (100) during operation, in particular to deactivate it for a short period of time, the cold gas spraying system (100) has a nozzle (110), from which the particle jet (50) emerges, a supply device (130), for supplying a particle stream (40) to the nozzle (110), and one or more actuators (21, 22, 23), which are formed such that the particle stream (40) and/or the particle jet (50) can be temporarily reduced, in particular temporarily interrupted, during operation, at least one of the actuators (21, 22, 23) being formed as a valve which is arranged between the supply device (130) and the nozzle (110).

### REFERENCE SIGNS

Gas source 20
Gas line 12
Particle lines 13, 13A, 13B, 13C
Particle stream 40
Particle jet 50
Cold gas spraying system 100
Nozzle 110
Supply device 130
Particle store 131
Actuator 21, 22, 23
Drive 220
Deflecting channel 230
Opening 240
First position A
Second position B
Buffer 180
Control device CTRL

What is claimed is:

1. A cold gas spraying system for generating an adjustable particle jet, the system comprising:
a nozzle from which the particle jet emerges;
a supply device for supplying a particle stream to the nozzle; and
one or more actuators operable to reduce the particle stream and/or the particle jet during operation;
wherein at least one of the actuators comprises a valve arranged between the supply device and the nozzle.

2. The cold gas spraying system as claimed in claim 1, wherein at least one of the actuators is arranged downstream of the supply device.

3. The cold gas spraying system as claimed in claim 1, wherein at least one of the actuators comprises a valve arranged to direct the particle stream back into the supply device.

4. The cold gas spraying system as claimed in claim 1, further comprising a buffer for temporarily buffering the particle stream.

5. The cold gas spraying system as claimed in claim 4, wherein at least one of the actuators has a first position supplying the particle stream to the nozzle and a second position to direct the particle stream into the buffer.

6. The cold gas spraying system as claimed in claim 1, further comprising a control device for adjusting a conveying rate of the supply device depending at least on a state of one of the actuators.

7. The cold gas spraying system as claimed in claim 1, further comprising a control device for adjusting a conveying rate of the supply device depending at least in part on a traveling speed of the nozzle.

8. The cold gas spraying system as claimed in claim 1, wherein particle lines are formed as buffers.

9. The cold gas spraying system as claimed in claim 1, wherein at least one of the actuators adjusts a traveling speed of the nozzle.

10. The cold gas spraying system as claimed in claim 1, wherein at least one of the actuators comprises a mechanical element blocking and/or deflecting the particle jet downstream, of the nozzle.

11. A method for controlling a cold gas spraying system, the method comprising:
generating a particle stream through a nozzle with a supply device;
activating at least one actuator during operation of the cold gas spraying system for at least temporarily reducing the particle stream.

12. The method as claimed in claim 11, further comprising activating at least one of the actuators based at least in part on a traveling speed of the nozzle.

13. The method as claimed in claim 11, further comprising actuating at least one actuator based at least in part on a conveying rate of the supply device.

14. The method as claimed in claim 11, further comprising controlling a conveying rate of the supply device depending at least in part on a state of at least one actuator.
